(19) United States
(12) Patent Application Publication
(10) Pub. No.: US 2025/0330622 A1
(43) Pub. Date: Oct. 23, 2025

(54) A METHOD, AN APPARATUS AND A COMPUTER PROGRAM PRODUCT FOR VIDEO CODING

(71) Applicant: Nokia Technologies Oy, Espoo (FI)

(72) Inventor: Jani LAINEMA, Tampere (FI)

(21) Appl. No.: 18/875,380

(22) PCT Filed: Mar. 22, 2023
(86) PCT No.: PCT/FI2023/050165

§ 371 Date: Dec. 16, 2024

(30) Foreign Application Priority Data
Jun. 17, 2022 (FI) 20225545

(51) Int. Cl. H04N 19/186; H04N 19/105; H04N 19/132; H04N 19/50

(52) U.S. Cl. CPC H04N 19/186; H04N 19/105; H04N 19/132; H04N 19/50

(57) ABSTRACT

The embodiments relate to a method for processing image and/or video data. The method comprises receiving a set of input samples; determining a set of reference samples with two types of colour information; determining a center representative of both of said two types of colour information; determining a lower representative and a higher representative based on the set of reference samples and the determined center representative of at least one of the two types of colour information; determining a first cross-component model according to the determined lower and center representatives, and determining a second cross-component model according to the determined higher and center representatives; and determining when a value of an input sample is smaller than or equal to at least one of the determined center representatives, and applying the first cross-component model to the input sample, otherwise applying the second cross-component model to the input sample.

### TECHNICAL FIELD

The present solution generally relates to video encoding and decoding.

### BACKGROUND

Video codec consists of an encoder that transforms the input video into a compressed representation suited for storage/transmission and a decoder that can uncompress the compressed video representation back into a viewable form. The encoder may discard some information in the original video sequence in order to represent the video in a more compact form (that is, at lower bitrate).

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for processing image and/or video data, the apparatus comprising means for receiving a set of input samples; means for determining a set of reference samples with two types of colour information; means for determining a center representative of both of said two types of colour information; means for determining a lower representative and a higher representative based on the set of reference samples and the determined center representative of at least one of the two types of colour information; means for determining a first cross-component model according to the determined lower and center representatives, and means for determining a second cross-component model according to the determined higher and center representatives; and means for determining when a value of an input sample is smaller than or equal to at least one of the determined center representatives, and applying the first cross-component model to the input sample, otherwise applying the second cross-component model to the input sample.

According to a second aspect, there is provided a method image and/or video data, the method comprising: receiving a set of input samples; determining a set of reference samples with two types of colour information; determining a center representative of both of said two types of colour information; determining a lower representative and a higher representative based on the set of reference samples and the determined center representative of at least one of the two types of colour information; determining a first cross-component model according to the determined lower and center representatives, and determining a second cross-component model according to the determined higher and center representatives; and determining when a value of an input sample is smaller than or equal to at least one of the determined center representatives, and applying the first cross-component model to the input sample, otherwise applying the second cross-component model to the input sample.

According to a third aspect, there is provided an apparatus image and/or video data, the apparatus comprising at least one processor, memory including computer program code, the memory and the computer program code configured to, with the at least one processor, cause the apparatus to perform at least the following: receive a set of input samples; determine a set of reference samples with two types of colour information; determine a center representative of both of said two types of colour information; determine a lower representative and a higher representative based on the set of reference samples and the determined center representative of at least one of the two types of colour information; determine a first cross-component model according to the determined lower and center representatives, and determine a second cross-component model according to the determined higher and center representatives; and determine when a value of an input sample is smaller than or equal to at least one of the determined center representatives, and apply the first cross-component model to the input sample, otherwise apply the second cross-component model to the input sample.

According to a fourth aspect, there is provided computer program product image and/or video data, the computer program product comprising computer program code configured to, when executed on at least one processor, cause an apparatus or a system to: receive a set of input samples; determine a set of reference samples with two types of colour information; determine a center representative of both of said two types of colour information; determine a lower representative and a higher representative based on the set of reference samples and the determined center representative of at least one of the two types of colour information; determine a first cross-component model according to the determined lower and center representatives, and determine a second cross-component model according to the determined higher and center representatives; and determine when a value of an input sample is smaller than or equal to at least one of the determined center representatives, and apply the first cross-component model to the input sample, otherwise apply the second cross-component model to the input sample.

According to an embodiment, wherein an average or a median is calculated for both of said two types of colour information to act as the center representative.

According to an embodiment, the cross-component model is defined by an output of a function applied to an input value.

According to an embodiment, the function comprises a linear mapping from an input value to the output value; or two distinct functions activated according to the determined center representative.

According to an embodiment, the following is carried out with respective means of the apparatus:
determining the set of reference samples comprising at least two types of values;
determining a first set of average values for both said at least two types of values of the set of reference samples;
determining a second set of average values for the reference samples having a first type of value smaller than or equal to the determined corresponding average value;
determining a third set average values for the reference samples having the first type of value larger than the determined corresponding value;
determining a first cross-component model using the determined first and second set of average values;
determining a second cross-component using the determined first and third set of average values;
determining a predicted value for a sample of one type using at least a sample of another type as input using the first cross-component model if said sample of another type is smaller or equal than the corresponding average of the first set of average values or using the second cross-component model if said sample of another type is larger than the corresponding average of the first set of average values.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of an encoding method;

FIG. 2 shows an example of a decoding method;

FIG. 3 shows an example of reference samples in luma-chroma space;

FIG. 4 shows an example of the average luma reference value and average chroma reference value;

FIG. 5 shows an example of determining average samples for a lower set and for higher set;

FIG. 6 shows an example of determining mapping functions for the lower set and for the higher set;

FIG. 7 is a flowchart illustrating a method according to an embodiment;

FIG. 8 shows an apparatus according to an embodiment.

### DESCRIPTION OF EXAMPLE EMBODIMENTS

In the following, several embodiments will be described in the context of one video coding arrangement. It is to be noted, however, that the present embodiments are not necessarily limited to this particular arrangement.

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

Video codec comprises an encoder and a decoder. The encoder is configured to transform input video into a compressed representation suitable for storage/transmission. The decoder is able to decompress the compressed video representation back into a viewable form. The encoder may discard some information in the original video sequence in order to represent the video in a more compact form, for example at a lower bitrate.

An elementary unit for the input to an encoder and the output of a decoder, respectively, in most cases is a picture. A picture given as an input to an encode may also be referred to as a source picture, and a picture decoded by a decoder may be referred to as a decoded picture or a reconstructed picture.

The source and decoded picture are each comprised of one or more sample arrays, such as one of the following sets of sample arrays:
Luma (Y) only (monochrome);
Luma and two chroma (YCbCr or YCgCo);
Green, Blue and Red (GBR, also known as RGB);
Arrays representing other unspecified monochrome or tri-stimulus color samplings (for example, YZX, also known as XYZ).

A picture may be defined to be either a frame or a field. A frame comprises a matrix of luma samples and possibly the corresponding chroma samples. A field is a set of alternate sample rows of a frame, and may be used as encoder input, when the source signal is interlaced. Chroma sample arrays may be absent (and hence monochrome sampling may be in use) or chroma sample arrays may be subsampled when compared to luma sample arrays.

A bitstream may be defined as a sequence of bits, which may in some coding formats or standards be in the form of a network abstraction layer (NAL) unit stream or a byte stream, which forms the representation of coded pictures and associated data forming one or more coded video sequence. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of the bitstream (EOB) NAL unit and which is the last NAL unit of the bitstream.

The phrase “along the bitstream” (e.g., indicating along the bitstream) or along a coded unit of a bitstream (e.g., indicating along a coded tile) may be used in claims and described embodiments to refer to transmission, signaling or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signalling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Hybrid video codecs, for example ITU-T H.263 and H.264 may encode video information in two phases. At first, pixel values in a certain picture area (or “block”) are predicted for example by motion compensation means (finding and indicating an area in one of the previously coded video frames that correspond closely to the block being coded) or by spatial means (using the pixel values around the block to be coded in a specified manner). In the first phase, predictive coding may be applied, for example, as so-called sample prediction and/or so-called syntax prediction. In the sample prediction, pixel of sample values in a certain picture area or “block” are predicted. These pixel or sample values can be predicted, for example, using one or more of motion compensation or intra prediction mechanism. Secondly, the prediction error, i.e., the difference between the predicted block of pixels and the original bock of pixels is coded. This may be done by transforming the difference in pixel values a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

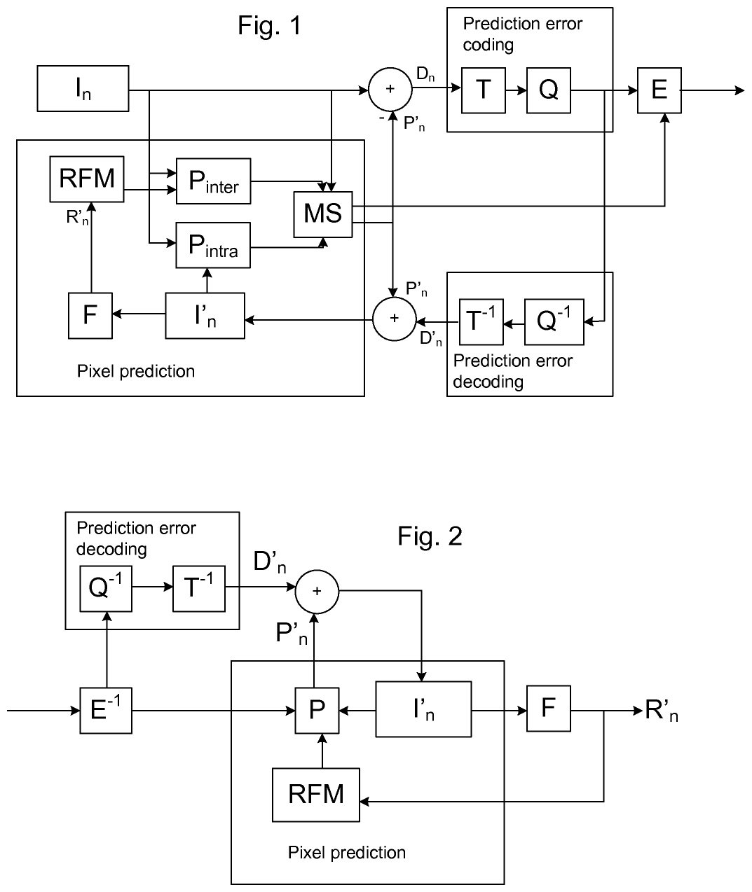

The example of the encoding process is illustrated in FIG. 1. FIG. 1 illustrates an image to be encoded (Iₙ); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pinter); intra prediction (Pintra); mode selection (MS) and filtering (F).

In some video codecs, such as H.265/HEVC, video pictures are divided into coding units (CU) covering the area of the picture. A CU comprises one or more prediction units (PU) defining the prediction process for the samples within the CU and one or more transform units (TU) defining the prediction error coding process for the samples in said CU. A CU may comprise a square block of samples with a size selectable from a predefined set of possible CU sizes. A CU with the maximum allowed size may be named as LCU (largest coding unit) or CTU (coding tree unit), and the video picture may be divided into non-overlapping CTUs. A CTU can be further split into a combination of smaller CUs, e.g., by recursively splitting the CTU and resultant CUs. Each resulting CU may have at least one PU and at least one TU associated with it. Each PU and TU can be further split into smaller PUs and TUs in order to increase the granularity of the prediction and prediction error coding processes, respectively. Each PU has prediction information associated with it, defining what kind of a prediction is to be applied for the pixels within that PU (e.g., motion vector information for inter predicted PUs and intra prediction directionality information for intra predicted PUs). Similarly, each TU is associated with information describing the prediction error decoding process for the samples within said TU (including e.g., DCT coefficient information). It may be signalled at CU level, whether prediction error coding is applied or not for each CU. In the case there is no prediction error residual associated with the CU, it can be considered there are no Tus for said CU. The division of the image into CUs, and division of CUs into PUs and TUs may be signaled in the bitstream allowing the decoder to reproduce the intended structure of these units.

The decoder may reconstruct the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder is configured to sum up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. An example of a decoding process is illustrated in FIG. 2. FIG. 2 illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

Instead, or in addition to approaches utilizing sample value prediction and transform coding for indicating the coded sample values, a color palette-based coding can be used. Palette based coding refers to a family of approaches for which a palette, i.e., a set of colours and associated indexes, is defined and the value for each sample within a coding unit is expressed by indicating its index in the palette. Palette based coding can achieve good coding efficiency in coding units with a relatively small number of color (such as image areas which are representing computer screen content, for example text or simple graphics). In order to improve the coding efficiency of palette coding, different kinds of palette index prediction approaches can be utilized, or the palette indexes can be run-length coded to be able to represent larger homogenous areas efficiently. Also, in the case the CU contains sample values that are not recurring within the CU, escape coding can be utilized. Escape coded samples are transmitted without referring to any of the palette indexes. Instead, their values may be indicated individually for each escape coded sample.

When a CU is coded in palette mode, the correlation between pixels within the CU is exploited using various prediction strategies. For example, mode information can be signaled for each row or pixels that indicates one of the following: the mode can be horizontal mode meaning that a single palette index is signaled and the whole pixel line shares this index; the mode can be vertical mode, where the whole pixel line is the same with the above line, and no further information is signaled; the mode can be normal mode where a flag is signaled for each pixel position to indicate whether it is the same with one of the left and other pixels—and if not, the color index itself is separately transmitted.

In video codecs, the motion information may be indicated with motion vectors associated with each motion compensated image block. Each of these motion vectors may represent the displacement of the image block in the picture to be coded (at the encoder side) or decoded (at the decoder side), and the prediction sources block in one of the previously coded or decoded pictures. In order to represent motion vectors efficiently, those may be coded differentially with respect to block specific predicted motion vectors. In video codecs, the predicted motion vectors may be created in a predefined way, for example calculating the media of the encoder or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information may be signaled among a list of motion field candidate list filled with motion field information of available adjacent/co-located blocks.

Video codecs may support motion compensated prediction from one source image (uni-prediction) and two sources (bi-prediction). In the case of uni-prediction, a single motion vector may be applied whereas in the case of bi-prediction, two motion vectors may be signaled and the motion compensated predictions from two sources may be averaged to create the final sample prediction. In the case of weighted prediction, the relative weights of the two predictions can be adjusted, or a signaled offset can be added to the prediction signal.

In addition to applying motion compensation for inter picture prediction, similar approach can be applied to intra picture prediction. In this case the displacement vector indicates where a block of samples can be copied from the same picture to form a prediction of the block to be coded or decoded. This kind of intra block copying methods can improve the coding efficiency substantially in presence of repeating structures within the frame-such as text or other graphics.

In video codecs, the prediction residual after motion compensation or intra prediction may be first transformed with a transform kernel (like DCT “Discrete-Cosine Transform”) and then coded. The reason for this is that often there still exists some correlation among the residual and transform can in many cases help reduce this correlation and provide more efficient coding.

Video encoders may utilize Lagrangian cost functions to find optimal coding modes, e.g., the desired macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . 1 )$$

where C is the Lagrangian cost to be minimized, D is the image distortion (e.g., Mean Squared Error) with the mode and motion vectors considered, and R is the number or bits needed to represent the required data to reconstruct the image block in the decoder (including the amount of data to represent the candidate motion vectors).

Scalable video coding refers to coding structure where one bitstream can contain multiple representation of the content at different bitrates, resolutions, or frame rates. In these cases, the receiver can extract the desired representation depending on its characteristics (e.g., resolution that matches best the display device). Alternatively, a server or a network element can extract the portions of the bitstream to be transmitted to the receiver depending on e.g., the network characteristics or processing capabilities of the receiver. A scalable bitstream may comprise a “base layer” providing the lowest quality video available and one or more enhancement layers that enhance the video quality when received and decoded together with the lower layers. In order to improve the coding efficiency for the enhancement layers, the coded representation of that layer may depend on the lower layers. E.g., the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codec using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and may indicate its use with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, following scalability modes exist:
Spatial scalability: Base layer pictures are coded at a lower resolution than enhancement layer pictures.
Bit-depth scalability: Base layer pictures are coded at lower bit-depth (e.g., eight bits) than enhancement layer picture (e.g., 10 or 12 bits).
Chroma format scalability: Enhance layer picture provide higher fidelity in chroma (e.g., coded in 4:4:4 chroma format) than base layer picture (e.g., 4:2:0 format).

In the aforementioned scalability cases, base layer information can be used to code enhancement layer to minimize the additional bitrate overhead.

Scalability can be enabled in two ways: a) by introducing new coding modes for performing prediction of pixel values or syntax from lower layers of the scalable representation; or b) by placing the lower layer pictures to the reference picture buffer (decoded picture buffer, DPB) of the higher layer. Approach a) is more flexible, and thus can provide better coding efficiency in most cases. However, the approach b), i.e., the reference frame-based scalability, can be implemented very efficiently with minimal changes to single layer codecs while still achieving majority of the coding efficiency gains available. A reference frame-based scalability codec can be implemented by utilizing the same hardware or software implementation for all the layers, just taking care of the DPB management by external means.

In order to be able to utilize parallel processing, images can be split into independently codable and decodable image segments (slices or tiles). Slices may refer to image segments constructed of certain number of basic coding units that are processed in default coding or decoding order, while tiles may refer to image segments that have been defined as rectangular image regions that are processed at least to some extent as individual frames.

A video may be encoded in YUV or YCbCr color space that is found to reflect some characteristics of the human visual system and allows using lower quality representation for Cb and Cr channels as human perception is less sensitive to the chrominance fidelity those channels represent.

Some cross-component prediction techniques are able to approximate non-linearities between the input and output datasets (e.g., input samples and output samples). For example, the cross-component linear model prediction (CCLM) as proposed in JVET document JVET-Z0063 includes a term based on a squared input sample which can model second order dependencies. Also, the multi-model linear model (MMLM) technique of ECM 3.0 video codec can model non-linearities to some extent by calculating two linear models independent from each other. Both approaches introduce additional complexities to video codec implementations as the number of parameters needed by the model increases compared to traditional two parameter linear model predictions. The MMLM technique has an additional drawback as it generates two independent models creating often a significant discontinuity at the transition point, where one model switches to the other.

A two parameter cross-component linear model prediction (CCLM) is used for example in the VVC/H.266 and ECM 3.0 video codecs. ECM 3.0 also uses a multi-mode linear model (MMLM) technique which generates two independent linear models and selects the one to be used for a specific input sample depending on if the value of the input sample is smaller or larger than a threshold. JVET-Z0064 introduces a convolutional cross-component (CCCM) for intra prediction, which includes a non-linear term able to model second order dependencies between the input and output of the model.

The present embodiments are targeted to a solution, where a threshold value and two cross-component models are calculated. One of the cross-component models is applied to the input sample when an input value is smaller than the threshold, and the other is applied to the input sample when an input value is larger than the threshold. Both cross-component models are calculated using the threshold value and an associated output values as the basis for the model creation, making the models intersect at the point determined by the threshold value. Threshold value and a corresponding output value can be determined by averaging a set of input and output reference samples, respectively. Once the threshold value is determined, the set of reference samples can be divided into two subgroups: one to be used for determining the cross-component model for input samples smaller than the threshold, and one to be used for determining the cross-component model for input samples larger than the threshold. A representable input-output sample pair can be calculated then for both the lower value subgroup and the higher value subgroup. This can be done, for example, by calculating the average input sample and the average output sample within those subgroups. The cross-component models for both lower and higher subgroups can then be determined based on the subgroup's representable input-output sample and another sample pair formed by the threshold value and its corresponding output sample value.

According to the present embodiments, the cross-component prediction models map sample values of one channel to the same spatial position in another channel. As in some cases, the locations of the samples in different channels are not fully aligned, the input samples may be aligned with the output samples, for example, by using interpolation means. The input or source channel may be a luma channel, and the output or destination channel is a chroma channel.

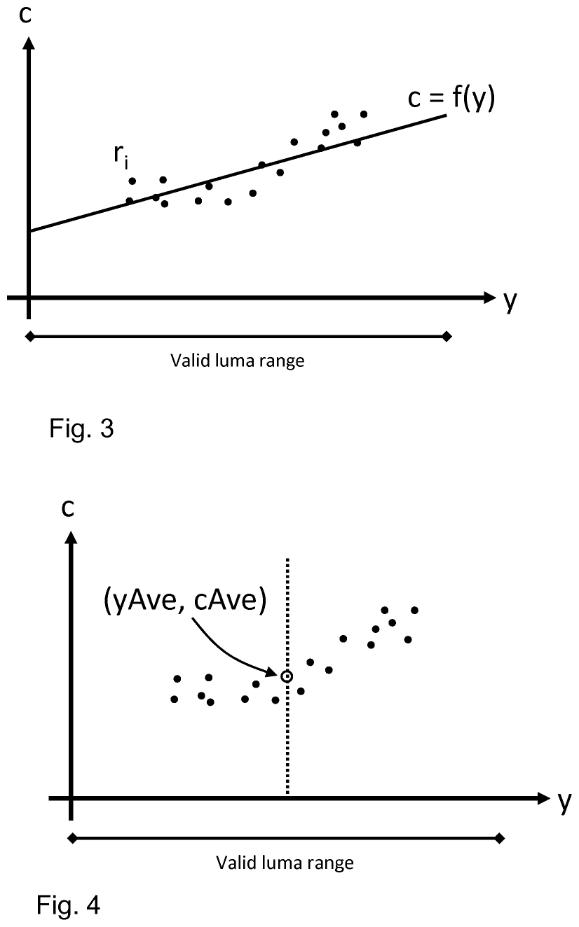

FIG. 3 illustrates reference samples in luma-chroma space. Each reference sample rᵢ has a luma value and a chroma value placing the reference sample in a certain position in that space. A cross-component model or function f can be determined to represent an approximated relationship between the reference luma and chroma samples. Once such model is established, the same model can be used to predict chroma values within a block of samples when corresponding luma values are available.

FIG. 4 illustrates the average luma reference value yAve and average chroma reference value cAve, and split of the reference samples into two sets. The lower set contains samples with a luma value below or equal to yAve, and the higher set contains samples with luma value above yAve.

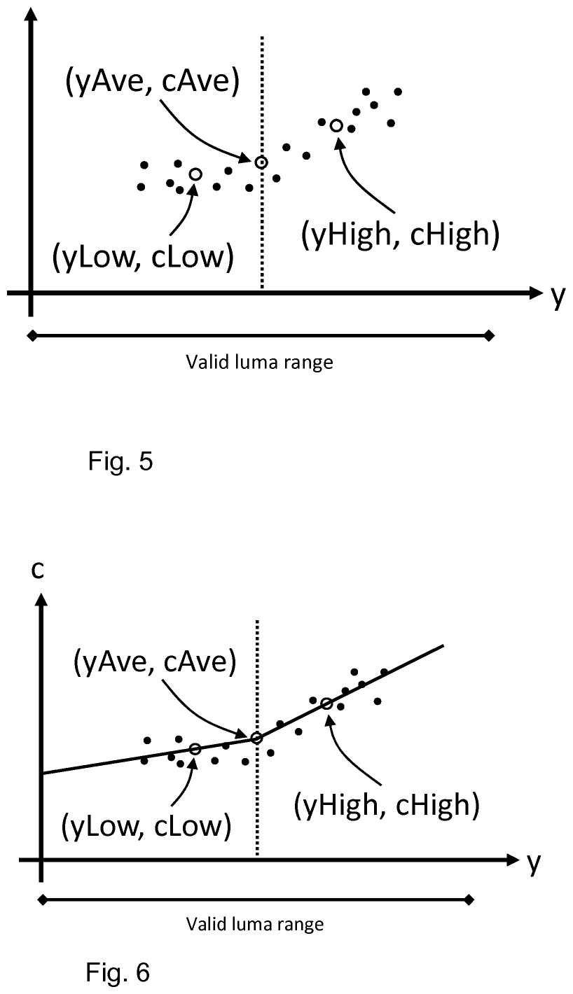

FIG. 5 illustrates determining average sample (yLow, cLow) for the lower set and average sample (yHigh, cHigh) for the higher set.

FIG. 6 illustrates determining a mapping function for the lower set using (yLow, cLow) and (yAve, cAve) and determining another mapping function for the higher set using (yHigh, cHigh) and (yAve, cAve).

In general, the cross-component prediction process can be described as an input value y, function f ( ) performed on y, and an output value c.

$$c = f ( y )$$

The function fcan be defined, for example, to perform linear mapping from y to c with a slope parameter a1 and an offset parameter a0.

$$c = f ( y ) = a 1 * y + a 0$$

Function fcan also be selected to include other inputs such as a certain of addition input samples from the spatial neighbourhood of the input sample y. The model can also consist of for example two distinct functions f and g which are activated depending on a determined threshold value t.

$$c = \{ \begin{matrix}f ( y ) , & when y \leq t \\ g ( y ) , & when y > t\end{matrix}$$

In the case of two first order models that can be written out with more detail as:

$$c = \{ \begin{matrix}f ( y ) = a 1 * y + a 0 , & when y \leq t \\ g ( y ) = b 1 * y + b 0 , & when y > t\end{matrix}$$

In practical implementations the first order and higher order parameters may be determined at certain precision to avoid the need for floating point operations. For example, if the first order parameter a1 is determined at k-bit precision, the corresponding mapping function can be given as:

$$c = f ( y ) = ( a 1 * y ) >> k + a 0$$

where >> is used to represent a bitwise shift operation.

With introduction of this restriction to the combined model formed by two or more cross-component models, the mapping can produce a smooth reconstruction independent on the input value y. Such selection is helpful in creating visually pleasing prediction block in chroma channels and it can also drive down the bitrate needed to represent multi-channel video or image content by reducing the need for residual coding to compensate for potential discontinuities in the predicted chroma blocks.

The cross-component model and their parameters can be determined in different ways to achieve the targeted behavior for the combined mapping function. An approach, according to an embodiment, comprises the following steps:
Determining a set of reference samples with a luma value and a chroma value, optionally using interpolation or other filtering means;
Determining average luma value yAve and average chroma value cAve for the set of reference samples. The average values can be also referred to as “center representative”;
Determining average luma value yLow and average chroma value cLow for the reference samples with luma value smaller than or equal to yAve. These values yLow and cLow can also be referred to as “lower representatives”;
Determining average luma value yHigh and average chroma value cHigh for the reference samples with luma value larger than yAve. These values yHigh and cHigh can also be referred to as “higher representatives”;
Determining a first cross-component model using values yAve, cAve, yLow and cLow,
Determining a second cross-component model using values yAve, cAve, yHigh and cHigh;
Determining a predicted chroma value using at least one luma value as input using:
   the first cross-component model if said luma value is smaller than or equal to yAve, or
   the second cross-component model if said luma value is larger than yAve.

As an alternative to average luma and chroma values, different representative values for the reference samples and subsets of reference samples can be used. For example, median luma and chroma values can be used instead of averages.

Different methods can be used to calculate the average luma and chroma values. For example, all the samples or a certain number of samples of the set which average values are to be determined can be considered. For example, to simplify the calculation process, only a 2\hat{ }N samples in the set or in the subset can be selected for average value calculation. With that kind of a selection, the division operation generally needed to calculate an average of a set of values can be substitute with a bitwise shift operation.

Similarly, the first cross-component model f(y) and the second cross-component model g(y) can be calculated differently from the average luma and chroma values. For example, a division operation or an approximation of it can be used following the pseudo-code below:

```
if ( y1 > y0 )
{
  dc = c1 − c0
  dy = y1 − y0
  x1 = ( ( dc << shift ) + dy/2) / dy
  x0 = cRef − ( yRef * a >> shift )
}
else
{
  x1 = 0
  x0 = cRef
}
```

In the above example, x0 is the zeroth order model parameter representing the bias and x1 the first order model parameter representing the slope of the model function. yRef and cRef represent a reference sample connecting the models and can be selected to be yAve and cAve, respectively. The shift represents accuracy of the slope parameter and can be selected to have for example a value of 8 or 10, or another positive integer. Input values y0 and c0 represent a first sample in luma-chroma space and y1 and c1 represent another sample in luma-chroma space through which the model is targeted to pass through. When determining a first cross-component model, y0, c0, y1 and c1 can be set to yLow, cLow, yAve and cAve, respectively. Similarly, when determining a second cross-component model, y0, c0, y1 and c1 can be set to yAve, cAve, yHigh and cHigh, respectively.

An alternative for such model calculation example can be given by substituting the division operation or approximate division operation “/” by using a look-up table. Using the same variable and defining DIV_BITS as 4, the following pseudo-code provides an example implementation.

```
DivTable = [ 16, 15, 14, 13, 13, 12, 12, 11, 11, 10, 10, 9, 9, 9, 9, 8 ]
  dc = c1 − c0
  dy = y1 − y0
  if ( dy > 0 )
  {
    x = floorLog2( dy )
    mask = ((1 << DIV_BITS) − 1)
    normDiff = (dy << DIV_BITS >> x) & mask
    v = DivTable[normDiff]
    y = floorLog2( abs( dc ) ) + 1
    add = 1 << y >> 1
    x1 = (dc * v + add) >> y
    shift = DIV_BITS + x − y
    if ( shift < 1 )
    {
      shift = 1
      x1 = ( (a == 0) ? 0 : (a < 0) ? −mask : mask )
    }
    x0 = cRef − ((a * yRef) >> shift)
  }
  else
  {
    x1 = 0
    x0 = cRef
    shift = 0
  }
```

According to an embodiment, a chroma value is predicted using a cross-component model which is defined by two mapping functions. The first mapping function may be generated using a first sample consisting of a luma-chroma value pair and a second sample consisting of another luma-chroma value pair. The second mapping function may be generated using the second sample and a third sample consisting of yet another luma-chroma value pair.

According to an embodiment, a chroma value is predicted using a cross-component model which is defined by at least two mapping functions. The first mapping function may be generated using a first sample consisting of a luma-chroma value pair and a second sample consisting of another luma-chroma value pair. The consecutive mapping functions may be generated using a sample that was also used in generation of an earlier model and a new sample not used to generate earlier models.

According to an embodiment, the luma value of the second sample consists of the average of luma values in a set of reference samples; the chroma value of the second sample consists of the average of chroma values in a set of reference samples.

According to an embodiment, the luma and chroma values of the first and the third samples are determined using different subsets of the reference sample set that was used to determine the luma and chroma values of the second sample.

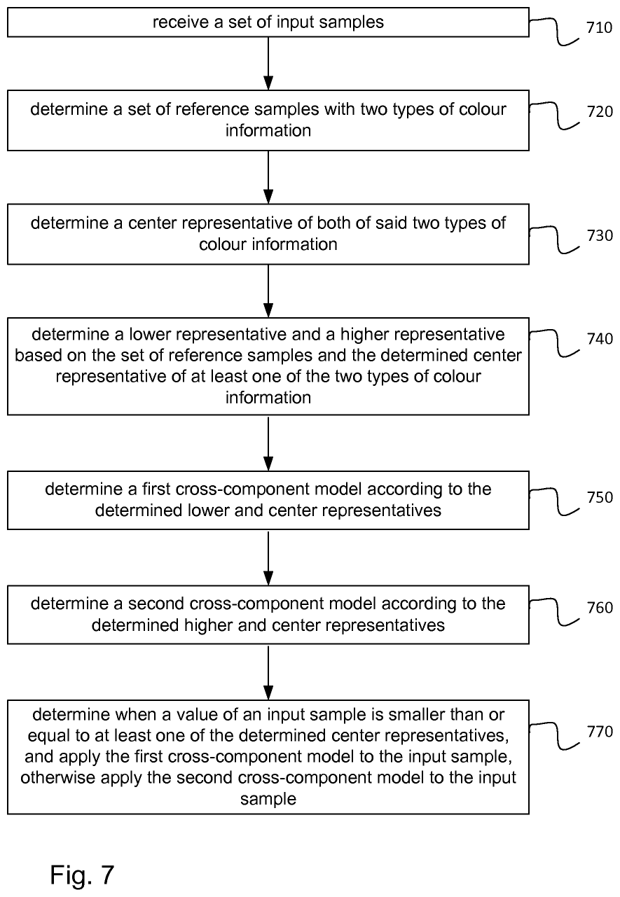

FIG. 7 is a flowchart illustrating a method according to an embodiment. In general, the method comprises receiving 710 a set of input samples; determining 720 a set of reference samples with two types of colour information; determining 730 a center representative of both of said two types of colour information; determining 740 a lower representative and a higher representative based on the set of reference samples and the determined center representative of at least one of the two types of colour information; determining 750 a first cross-component model according to the determined lower and center representatives, and determining 760 a second cross-component model according to the determined higher and center representatives; and determining 770 when a value of an input sample is smaller than or equal to at least one of the determined center representatives, and applying the first cross-component model to the input sample, otherwise applying the second cross-component model to the input sample. Each of the steps can be implemented by a respective module of a computer system.

An apparatus according to an embodiment comprises means for receiving a set of input samples; means for determining a set of reference samples with two types of colour information; means for determining a center representative of both of said two types of colour information; means for determining a lower representative and a higher representative based on the set of reference samples and the determined center representative of at least one of the two types of colour information; means for determining a first cross-component model according to the determined lower and center representatives, and means for determining a second cross-component model according to the determined higher and center representatives; and means for determining when a value of an input sample is smaller than or equal to at least one of the determined center representatives, and applying the first cross-component model to the input sample, otherwise applying the second cross-component model to the input sample. The means comprises at least one processor, and a memory including a computer program code, wherein the processor may further comprise processor circuitry. The memory and the computer program code are configured to, with the at least one processor, cause the apparatus to perform the method of FIG. 7 according to various embodiments.

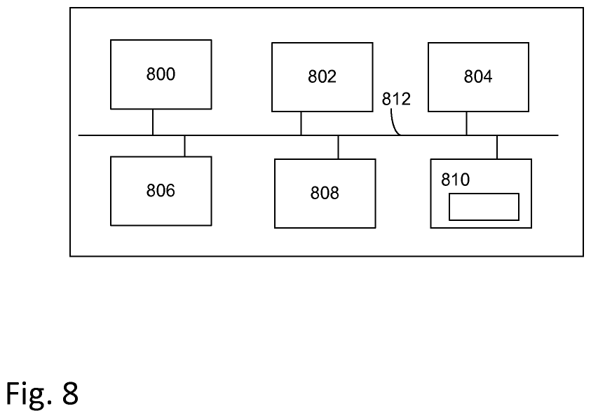

FIG. 8 illustrates an apparatus according to an embodiment. The generalized structure of the apparatus will be explained in accordance with the functional blocks of the system. Several functionalities can be carried out with a single physical device, e.g., all calculation procedures can be performed in a single processor if desired. A data processing system of an apparatus according to an example of FIG. 8 comprises a main processing unit 800, a memory 802, a storage device 804, an input device 806, an output device 808, and a graphics subsystem 810, which are all connected to each other via a data bus 812.

The main processing unit 800 is a processing unit arranged to process data within the data processing system. The main processing unit 800 may comprise or be implemented as one or more processors or processor circuitry. The memory 802, the storage device 804, the input device 806, and the output device 808 may include other components as recognized by those skilled in the art. The memory 802 and storage device 804 store data in the data processing system 800. Computer program code resides in the memory 802 for implementing, for example, machine learning process.

The input device 806 inputs data into the system while the output device 808 receives data from the data processing system and forwards the data, for example to a display. While data bus 812 is shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone, or an Internet access device, for example Internet tablet computer.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-11. (canceled)

12. An apparatus comprising at least one processor, memory including computer program code, the memory and the computer program code configured to, with the at least one processor, cause the apparatus to perform at least the following:
receiving a set of input samples;
determining a set of reference samples from the set of input samples with two types of color information;
determining center representatives of both of said two types of color information;
determining a lower representative and a higher representative of at least one of the two types of color information based on the set of reference samples and the determined center representative;
determining a first cross-component model based on the determined lower and the center representatives;
determining a second cross-component model based on the determined higher and the center representatives; and
applying the first cross-component model to an input sample when it is determined that a value of the input sample is smaller than or equal to at least one of the determined center representatives, otherwise applying the second cross-component model to the input sample.

13. The apparatus according to claim 12, wherein the apparatus upon execution caused performing calculating an average or a median for both of said two types of color information to act as the center representatives.

14. The apparatus according to claim 12, wherein a cross-component model is defined by an output of a function applied to an input value.

15. The apparatus according to claim 14, wherein the function comprises a linear mapping from the input value to an output value; or two distinct functions activated according to the determined center representative.

16. The apparatus according to claim 12, wherein the apparatus upon execution caused to perform determining the set of reference samples comprising at least two types of values;
determining a first set of average values for both said at least two types of values of the set of reference samples;
determining a second set of average values for the set of reference samples comprising a first type of value smaller than or equal to the determined corresponding average value;
determining a third set average values for the reference samples comprising the first type of value larger than the determined corresponding value;
determining the first cross-component model using the determined first and second set of average values;
determining a second cross-component using the determined first and third set of average values; and
determining a predicted value for a sample of one type using at least a sample of another type as input using the first cross-component model when said sample of another type is smaller or equal than corresponding average of the first set of average values or using the second cross-component model when said sample of another type is larger than the corresponding average of the first set of average values.

17. A method comprising:
receiving a set of input samples;
determining a set of reference samples from the set of input samples with two types of color information;
determining center representatives of both of said two types of color information;
determining a lower representative and a higher representative of at least one of the two types of color information based on the set of reference samples and the determined center representative;
determining a first cross-component model based on the determined lower and the center representatives;
determining a second cross-component model based on the determined higher and the center representatives; and
applying the first cross-component model to an input sample, when a value of an input sample is smaller than or equal to at least one of the determined center representatives, otherwise applying the second cross-component model to the input sample.

18. The method according to claim 17, further comprising calculating an average or a median for both of said two types of color information to act as the center representatives.

19. The method according to claim 17, wherein a cross-component model is defined by an output of a function applied to an input value.

20. The method according to claim 19, wherein the function comprises a linear mapping from the input value to an output value; or two distinct functions activated according to the determined center representative.

21. The method according to claim 17, further comprising:
determining the set of reference samples comprising at least two types of values;
determining a first set of average values for both said at least two types of values of the set of reference samples;
determining a second set of average values for the reference set of samples comprising a first type of value smaller than or equal to the determined corresponding average value;
determining a third set average values for the reference samples comprising the first type of value larger than the determined corresponding value;
determining the first cross-component model using the determined first and second set of average values;
determining a second cross-component using the determined first and third set of average values; and
determining a predicted value for a sample of one type using at least a sample of another type as input using the first cross-component model when said sample of another type is smaller or equal than corresponding average of the first set of average values or using the second cross-component model when said sample of another type is larger than the corresponding average of the first set of average values.
